(19) United States
(12) Patent Application Publication
(10) Pub. No.: US 2025/0132348 A1
(43) Pub. Date: Apr. 24, 2025

(54) HYBRID COATING FOR LITHIUM METAL PROTECTION

(71) Applicant: GM Global Technology Operations LLC, Detroit, MI (US)

(72) Inventors: Wai Ping Gloria Tam, Troy, MI (US); Xingcheng Xiao, Troy, MI (US); Tsz Yuet Matthew Chow, Sterling Heights, MI (US)

(21) Appl. No.: 18/490,203

(22) Filed: Oct. 19, 2023

(51) Int. Cl. H01M 4/62; H01M 4/02; H01M 4/04; H01M 4/36; H01M 4/38

(52) U.S. Cl. CPC H01M 4/628; H01M 4/0426; H01M 4/366; H01M 4/382; H01M 2004/021; H01M 2004/027; H01M 2220/20

(57) ABSTRACT

A method of forming a lithium ion battery, a lithium ion battery anode, and a lithium ion battery for a vehicle. The method includes exposing a first surface of a lithium layer to carbon dioxide gas and forming a lithium carbonate layer on the first surface of the lithium layer. The method further includes depositing a fluoropolymer layer on a second surface of the lithium carbonate layer to provide a lithium anode. The battery includes one or more battery cells including the anode for the lithium ion battery. The anode includes a lithium layer including a first surface, and a hybrid coating layer disposed on the first surface, wherein the hybrid coating layer includes a plurality of lithium fluoride domains and a plurality of lithium carbonate domains within a carbonaceous matrix.

### INTRODUCTION

Electric and hybrid electric vehicle technology has been enabled by the development and deployment of rechargeable, secondary batteries that supplant or augment an internal combustion engine to provide energy to the powertrain. Secondary batteries include lithium ion batteries, which generally include a cathode, anode, separator, and electrolyte. The cathode provides a source of lithium ions (Li+), the anode stores and releases lithium ions received from the cathode, and the separator prevents the cathode and anode from contacting. The electrolyte provides a medium between the cathode and anode through which the lithium ions travel. The type and quality of the materials forming these battery components greatly affect the capacity, number of charge and discharge cycles, and overall performance of the batteries.

For example, anode chemistries must resist volume changes and dendrite formation to maintain battery performance and various anode chemistries have been examined to provide robust anode materials. Lithium, for example, could be an advantageous anode material given its relatively low density, its low negative electrochemical potential, and high theoretical specific capacity. However, lithium is reactive with water, requiring that lithium anodes be stored in low humidity environments during formation, shipping, and assembly. Even in dry room environments with 1 percent relative humidity and a dew point of −40 degrees Celsius, lithium may react with moisture present in the air as well as carbon dioxide in the environment. Initially, lithium (Li) reacts with water (H₂O) to form lithium hydroxide (LiOH) and the lithium hydroxide (LiOH) reacts with carbon dioxide (CO₂) to form lithium carbonate (Li₂CO₃). While the lithium carbonate forms a passivation layer, it is brittle and lithium is soft, and as the lithium bends, the lithium carbonate fractures, further exposing lithium to the environment and forming more lithium carbonate. In addition, lithium carbonate does not dissolve in the electrolyte after cell assembly, reducing and even blocking lithium transport.

The above can make lithium handling difficult when manufacturing lithium anodes. Given these difficulties, other anode materials have been examined and employed. For example, graphite is commonly used as an anode given its physical stability during the charge and discharge processes. Silicon has also been identified as a useful material for use in lithium ion battery anodes given its stability compared to lithium and its relatively higher energy density compared to graphite.

Thus, while present secondary lithium ion battery anodes achieve their intended purpose, there is a need for new and improved secondary lithium ion battery anodes.

### SUMMARY

According to several aspects, the present disclosure relates to a method of forming a lithium ion battery. The method includes exposing a first surface of a lithium layer to carbon dioxide gas and forming a lithium carbonate layer on the first surface of the lithium layer. The method further includes depositing a fluoropolymer layer on a second surface of the lithium carbonate layer to provide a lithium anode.

In embodiments, forming the lithium carbonate layer includes forming a lithium carbonate layer exhibiting a thickness of less than 50 nanometers.

In any of the above embodiments, depositing the fluoropolymer layer includes depositing a plurality of fluoropolymer fragments of a fluoropolymer using a physical deposition process, wherein the plurality of fluoropolymer fragments impinge on the lithium carbonate layer. In further embodiments, depositing the fluoropolymer layer includes depositing a fluoropolymer having a thickness in the range of 5 nanometers to 100 nanometers. In yet further embodiments, depositing the fluoropolymer layer includes depositing the plurality of fluoropolymer fragments of at least one of polyvinyl fluoride (PVD), polyvinylidene fluoride (PVDF), polytetrafluoroethylene (PTFE), polyhexafluoropropylene (PHFP), and polychlorotrifluoroethylene (PCTFE), tetrafluoroethylene (TFE), perfluoroalkoxy alkane (PFA), polytetrafluoroethylene perfluoro methylvinylether (methylfluoroalkoxy, MFA), ethylene tetrafluoroethylene (ETFE), fluorinated ethylene propylene (FEP), and ethylene-chlorotrifluoroethylene (ECTFE).

In embodiments of the above, the fluoropolymer layer is deposited using a physical deposition process includes depositing the fluoropolymer layer by thermal evaporation of the fluoropolymer from a fluoropolymer target. In alternative, or additional embodiments, depositing the fluoropolymer layer using a physical deposition process includes depositing the fluoropolymer layer by sputtering the fluoropolymer from a fluoropolymer target.

In any of the above embodiments, the method further includes forming the lithium layer by thermally evaporating lithium and depositing the lithium on a substrate. In embodiments, the substrate is an anode current collector.

In any of the above embodiments, the method further includes assembling the lithium anode into a battery cell. In embodiments, assembling the lithium anode into a battery cell includes positioning a separator between a cathode and the lithium anode. In embodiments, the cathode is formed on a cathode current collector and the anode is formed on an anode current collector.

In further embodiments, the method further includes defluorinating the fluoropolymer layer and forming a hybrid coating layer including a plurality of lithium fluoride domains and a plurality of lithium carbonate domains. In embodiments, the method further includes forming a carbonaceous matrix around the plurality of lithium fluoride domains and the plurality of lithium carbonate domains. And, in yet further embodiments, the method includes sealing the battery cell in a pouch and introducing an electrolyte into the battery cell.

According to various additional aspects, the present disclosure relates to an anode for a lithium ion battery. The anode includes a lithium layer including a first surface. A lithium carbonate layer is disposed on the first surface, wherein the lithium carbonate layer includes a second surface. In addition, a fluoropolymer layer disposed on the second surface. In embodiments, the lithium carbonate layer exhibits a thickness of less than 50 nanometers. In any of the above embodiments, the fluoropolymer layer exhibits a thickness of 5 nanometers to 100 nanometers. In embodiments, the fluoropolymer layer is formed of one or more of the following fluoropolymers: polyvinyl fluoride (PVD), polyvinylidene fluoride (PVDF), polytetrafluoroethylene (PTFE), polyhexafluoropropylene (PHFP), and polychlorotrifluoroethylene (PCTFE), tetrafluoroethylene (TFE), perfluoroalkoxy alkane (PFA), polytetrafluoroethylene perfluoro methylvinylether (methylfluoroalkoxy, MFA), ethylene tetrafluoroethylene (ETFE), fluorinated ethylene propylene (FEP), and ethylene-chlorotrifluoroethylene (ECTFE).

According to various further aspects, the present disclosure relates to a lithium ion battery for a vehicle. The lithium ion battery includes one or more battery cells, wherein each battery cell includes a cathode disposed on a cathode current collector, an anode disposed on an anode current collector, a porous separator between the cathode and anode, and an electrolyte infiltrating the porous separator. The anode includes a lithium layer including a first surface, and a hybrid coating layer disposed on the first surface. The hybrid coating layer includes a plurality of lithium fluoride domains and a plurality of lithium carbonate domains within a carbonaceous matrix. The lithium ion battery further includes a pouch defining a volume for receiving the battery cell, an anode tab welded to a portion of the anode current collector extending from the pouch, and a cathode tab welded to a portion of the cathode current collector extending from the pouch.

### BRIEF DESCRIPTION OF DRAWINGS

The drawings described herein are for illustration purposes only and are not intended to limit the scope of the present disclosure in any way.

FIG. 1 illustrates a vehicle including a propulsion system utilizing a battery according to the various embodiments described herein.

FIG. 2A illustrates a battery including one or more lithium ion battery cells as illustrated in FIG. 2B, according to the various embodiments described herein.

FIG. 2B illustrates a lithium ion battery cell, according to the various embodiments of described herein.

FIG. 3 illustrates a method of forming a lithium anode including a hybrid coating, according to the various embodiments described herein.

FIG. 4A illustrates a lithium layer including a layer of lithium carbonate deposited on the lithium, according to the various embodiments described herein.

FIG. 4B illustrates a lithium layer including a layer of fluoropolymer deposited on the lithium carbonate layer forming a hybrid coating layer on the lithium layer, according to the various embodiments described herein.

FIG. 4C illustrates a hybrid coating layer after difluorination of the fluoropolymer is initiated, according to the various embodiments described herein.

FIG. 5 illustrates a physical vapor deposition system, according to the various embodiments described herein.

FIG. 6 illustrates a plasma enhanced chemical vapor deposition system, according to the various embodiments described herein.

FIG. 7 illustrates a method of forming a battery and initiating defluorination of the fluoropolymer, according to the various embodiments described herein.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to hybrid coatings for lithium anodes used in lithium ion battery cells, batteries including such battery cells, and vehicles including such batteries, as well as methods of manufacturing lithium anodes including hybrid coatings. As used herein, the term “vehicle” is not limited to automobiles. While the present technology is described primarily herein in connection with electric vehicles, the technology is not limited to electric vehicles, but hybrid electric vehicles as well. In addition, the concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites and emergency back-up power supplies, and permanent power stations associated with buildings and equipment, all of which may be powered by, for example, solar or wind-powered generator systems, power mains, and fuel based power generators such as gasoline or diesel generators as well as sterling engines.

FIG. 1 illustrates a vehicle 100 including a propulsion system 120. The propulsion system 120 generally includes an electric motor 124 and a secondary battery 126 for powering the electric motor 124. In many embodiments of the propulsion system 120, the propulsion system 120 includes an inverter 128 for changing power from DC (direct current) as provided by the battery 126 to AC (alternating current) as used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134.

The electric motor 124, powered by the battery 126, includes a stator 142 and a rotor 144 arranged with the stator 142. The stator 142 is the stationary part of the electric motor 124 and provides a rotating magnetic field the stationary magnetic field of the rotor 144 tries to align with. This causes the rotor 144 to rotate, in what may be referred to as “motoring” mode. In other applications the rotor's 144 rotating field (as caused by physical rotation) generates an electric current in the stator 142—this mode of operation is referred to as “generation” mode and the electric motor 124 used in this way is referred to as generator. In traction motor vehicle applications, the motoring mode provides motion to the vehicle 100, whereas generation mode recovers energy when the vehicle is in the process of stopping. The recovered energy is stored in the vehicle battery 126.

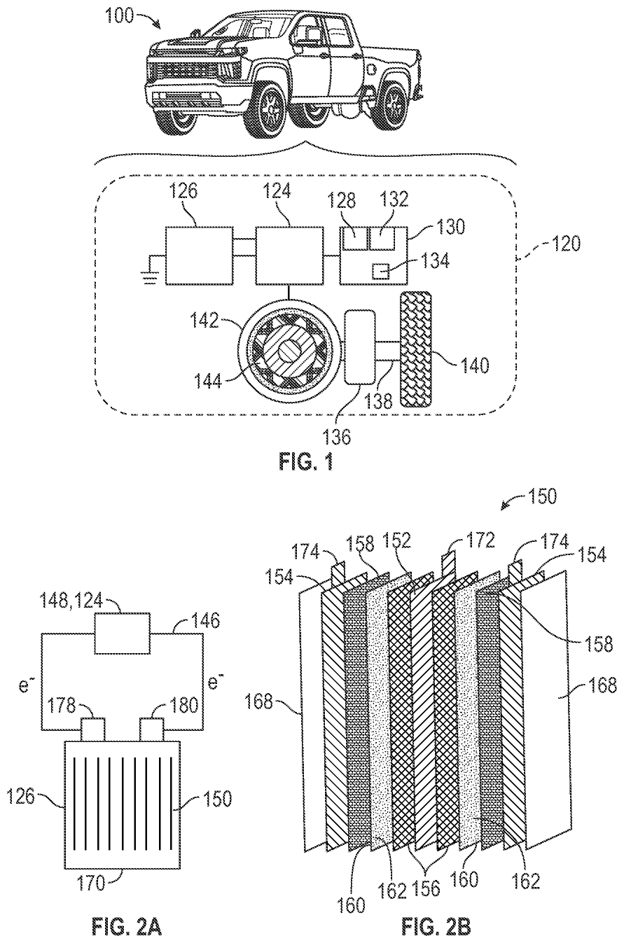

FIGS. 2A and 2B illustrate an example of a secondary battery 126 for powering an electric vehicle 100. The battery 126 is connected to a load 148, such as an electric motor 124. The battery 126 is discharged upon application of a load and recharged upon the application of an external power source. The battery 126 includes one or more battery cells 150, assembled together. Each battery cell 150 generally includes a cathode current collector 152, an anode current collector 154, a cathode 156, an anode 158, a separator 160, and electrolyte 162. During discharge, when the battery 126 is powering a load 124, lithium ions (Li+) move from the anode 158 to the cathode 156 through the separator 160 by way of the electrolyte 162. Equivalent electrons (e−) move through the circuitry 146 from the cathode 156 to the anode 158, providing voltage to the load 124. While charging, upon application of an external voltage, lithium ions move from the cathode 156 to the anode 158 by way of the electrolyte 162 through the separator 160 and may be intercalated into the anode 158. The battery cell 150 is packaged in a volume defined by a pouch 168, which seals around the periphery of the cathode current collector 152, the anode current collector 154, the cathode 156, the anode 158, the separator 160, and the electrolyte 162. As illustrated in FIG. 2B, the battery cell 150 includes two anode current collectors 154 and one cathode current collector 152. Alternatively, two cathode current collectors 152 may be present with one anode current collector 154, or one anode current collector 154 and one cathode current collector 152 may be present. In addition, a portion of the cathode current collector 152 extends out from the pouch 168 and is welded to a cathode tab 172 and a portion of the anode current collector 154 extends out from the pouch 168 and is welded to an anode tab 174. The cathode tabs 172 are connected to a cathode bus bar 178 and the anode tabs 174 are connected to anode bus bars 180.

The cathode current collector 152 and anode current collector 154 are formed from conductive materials. In embodiments, the cathode current collector 152 may include one or more of aluminum, nickel, and stainless steel; and the anode current collector 154 may include one or more of copper, nickel, stainless steel, and titanium. The current collectors 152, 154 are illustrated as being in the form of a foil; however, it should be appreciated that other forms may be exhibited. The cathode current collector 152 and anode current collector 154 are impermeable to moisture, preventing moisture ingress from the collector side of the cathode 156 and anode 158. In embodiments, the cathode current collector 152 exhibits a thickness in the range of 5 micrometers to 15 micrometers, including all values and ranges therein, and the anode current collector 154 exhibits a thickness in the range of 5 micrometers to 15 micrometers, including all values and ranges therein.

The cathode 156 includes materials that provide a source of lithium ions (Li+) and can undergo reversible insertion or intercalation of lithium ions, determining the capacity and average voltage of a battery. The cathode materials include lithium and an oxide or phosphate of one or more transition metals, such as cobalt oxide, manganese oxide, manganese phosphate, iron phosphate, and lithium nickel manganese cobalt oxide. The cathode 156 exhibits a thickness in the range of 20 to 200 micrometers, including all values and ranges therein. In embodiments, the cathode 156 is applied to the cathode current collector 152 as a coating using a deposition process, such as a slurry based process, hot roll pressing process, extrusion, or additive manufacturing. The combined cathode 156 and cathode current collector 152 provide a cathode electrode, as referenced further herein.

The anode 158 includes materials that can undergo reversible insertion or intercalation of lithium ions at a lower electrochemical potential than the cathode 156 material, such that an electrochemical potential difference exists between the anode 158 and cathode 156. Reference is made to FIG. 4C, which illustrates an anode 158 according to embodiments, herein. The anode 158 includes a hybrid coating layer 164 of lithium fluoride (LiF) domains and lithium carbonate (Li₂CO₃) domains (both designated 196) in a carbonaceous matrix 198 disposed on a lithium layer 166. The anode 158 exhibits a thickness in the range of 1 micrometers to 50 micrometers, including all values and ranges therein. In embodiments, the anode 158 is applied to the anode current collector 154, forming a coating on the anode current collector 154, using a lamination process, or alternatively, a processes such as sputtering deposition, or e-beam evaporation may be used to deposit the anode 158. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator 160 is thermoplastic and includes at least one of polyethylene, polypropylene, polyamide, polytetrafluoroethylene, polyvinylidene fluoride, and polyvinyl chloride. In further embodiments, the separator 160 may be filled with a material such as glass fiber. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 7 micrometers to 50 micrometers, including all values and ranges therein.

The electrolyte 162 provides a medium between the cathode 156 and anode 158 through which lithium ions. The medium may be a liquid, gel, or solid, and capable of conducting the lithium ions between the cathode 156 and the anode 158. The electrolyte 162 infiltrates the porous separator 160 and wets the surfaces of the cathode 156 and anode 158 as well as the separator 160. In embodiments, the electrolyte 162 is a non-aqueous organic solvent. In further embodiments, the electrolyte 162 is a non-aqueous aprotic organic solvent including or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethanc, ethoxymethoxy ethane), cyclic ethers (e.g., tetrahydrofuran, 2-methyltetrahydrofuran), 1,3-dioxolane).

In any of the above embodiments, the electrolyte 162 may include a lithium salt dissolved in the one or more organic solvents. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato) borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl) imide (LiN(FSO₂)₂)(LiSFI), lithium (triethylene glycol dimethy 1 ether) bis(trifluoromethanesulfonyl)imide (Li(G3)(TFSI), and lithium bis(trifluoromethanesulfonyl) azanide (LiTFSA). The lithium salt may be present in the electrolyte 162 at a concentration (moles of salt per liter of solvent) ranging from 1 M to 4 M, including all values and ranges therein, such as 2 M or 3 M.

Further, the electrolyte 162 may include a number of additives, such as, but not limited to, vinyl carbonate, vinyl-ethylene carbonate, propane sulfonate, and combinations thereof. Other additives can include diluents which do not coordinate with lithium ions but can reduce viscosity of the electrolyte 162, such as bis(2,2,2-trifluoroethyl) ether (BTFE), and flame retardants, such as triethyl phosphate.

In embodiments, the battery cells 150 are separated by the separator 160, which may wrap, at least partially, around each battery cell 150. Alternatively, or in addition, the battery cells 150 are heat sealed in a pouch 168 and stacked in a casing 170. The pouch 168 is formed from a non-conductive material, such as thermoplastic film coated in, for example, aluminum. In embodiments, the thermoplastic film includes polyethylene or polypropylene.

In embodiments, the cathode current collectors 152 are joined together using one or more cathode bus bars 178, and the anode current collectors 154 are joined together using one or more anode bus bars 180. The bus bars 178 and 180 extend out of the battery 126 or include connectors that extend out of the battery 126. The bus bars 178, 180 are then connected, directly or indirectly, to the load 148.

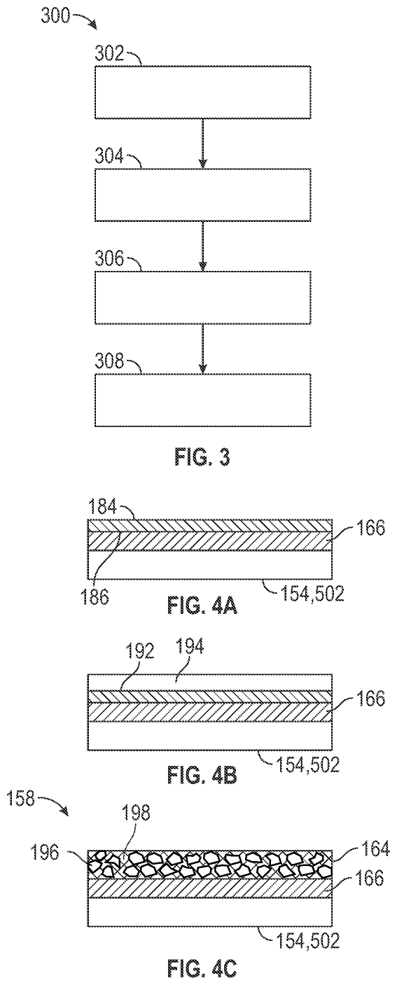

Reference is made now to FIG. 3, which illustrates an embodiment of a method 300 of forming a lithium anode 158 including the hybrid coating layer 164 of lithium fluoride (LiF) and lithium carbonate (Li₂CO₃) 196 in a carbonaceous matrix 198, with further reference to FIGS. 4A through 4B, which illustrate the lithium anode 158 upon application of the hybrid coating, and FIG. 4C, which illustrates the lithium anode 158 after battery assembly.

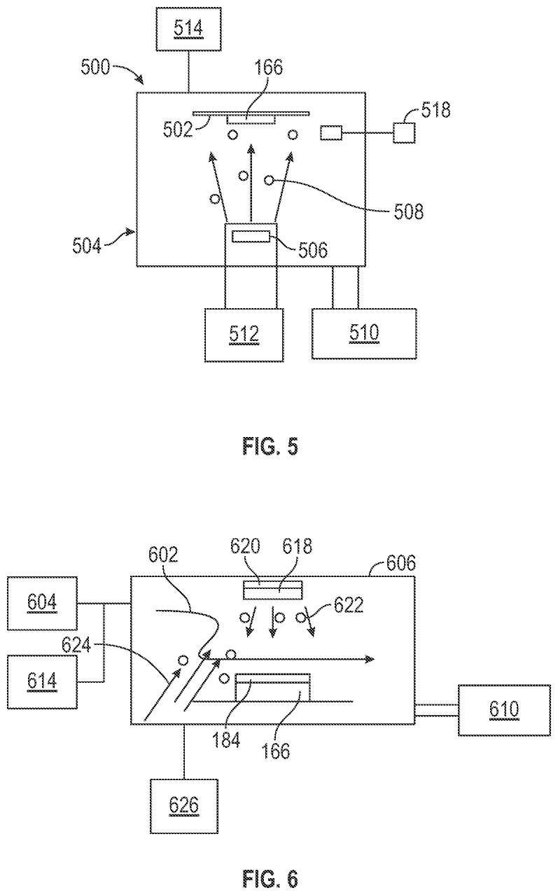

At block 302, and with further reference to FIG. 5 illustrating a physical vapor deposition system 500, the method 300 optionally proceeds with forming the lithium layer 166. The lithium layer 166 may be formed on a substrate 502, such as an anode current collector 154, by, for example, physical vapor deposition using a process such as thermal evaporation, sputtering, or lamination of lithium onto a substrate 502. During deposition, the substrate 502 is placed into a first process chamber 504 and a vacuum is drawn on the process chamber 504 using a vacuum pump system 510, which typically includes a multiple stage vacuum pump(s). A lithium source 506, such as a lithium target including solid lithium or lithium powder, is provided opposing the substrate 502 in the process chamber 504. The lithium 508 is evaporated from the lithium source 506 utilizing one of resistance heating or e-beam evaporation and ejected towards the substrate 502. Power is supplied to the heating device using a power supply 512. The lithium is deposited to a thickness of less than 10 nanometers, including all values and ranges from 1 nanometer up to 10 nanometers, to form the lithium layer 166. A shutter 520 may be used to control the flow of evaporated lithium and a deposition monitor 518 may be employed to determine the deposition rate and thickness of the lithium. In alternative embodiments, the lithium layer 166 may be received preformed and packaged, with or without the anode current collector 154.

At block 304, a layer of lithium carbonate (Li₂CO₃) 184 is formed on the lithium layer 166. To form the lithium carbonate layer 184, a chemical vapor deposition process may be employed, such as atomic layer deposition or low pressure chemical vapor deposition. The exposed surface(s) of the lithium layer 166 is exposed to carbon dioxide gas 602 supplied to a process chamber 606 of a chemical vapor deposition system 600, as illustrated in FIG. 6, or to the first process chamber 504 incorporating the functionalities and features described herein with reference to FIG. 6. Prior to introducing the lithium layer 166, a vacuum is drawn on the process chamber 606 by a vacuum system 610 including one or more vacuum pumps, and then the lithium layer 166 is exposed to the process chamber environment. Carbon dioxide is supplied by a carbon dioxide source 604 at a feed rate, and in an amount, sufficient to grow a lithium carbonate layer 184 of less than less than 50 nanometers in thickness, including all values and ranges therein, such as from 1 nanometer up to 50 nanometers, on the lithium layer 166.

At block 306, a fluoropolymer layer 190 is then deposited on the surface 192 of the lithium carbonate layer 184. The fluoropolymer layer 194 exhibits a thickness in the range of 5 nanometers to 100 nanometers, including all values and ranges therein. The fluoropolymer layer 190 is deposited by a physical deposition process such as thermal evaporation or sputtering. Using the process chamber 606 of FIG. 6, or the process chamber 504 FIG. 5, any excess carbon dioxide, if present, may be removed from the process chamber 606, 504 and an inert gas, such as argon (Ar), may be provided to the process chamber from an inert gas source 614, 514. A fluoropolymer target 618, 506 is included in the process chamber 606, 504. The fluoropolymer target 618, 506 in embodiments, includes one or more of the following fluoropolymers: polyvinyl fluoride (PVD), polyvinylidene fluoride (PVDF), polytetrafluoroethylene (PTFE), polyhexafluoropropylene (PHFP), and polychlorotrifluoroethylene (PCTFE), tetrafluoroethylene (TFE), perfluoroalkoxy alkane (PFA), polytetrafluoroethylene perfluoro methylvinylether (i.e., methylfluoroalkoxy (MFA)), ethylene tetrafluoroethylene (ETFE), fluorinated ethylene propylene (FEP), and ethylene-chlorotrifluoroethylene (ECTFE). In the case of thermal evaporation, the fluoropolymer target 618, 506 is heated to its decomposition temperature by a heating device such as a laser or a filament. Fluoropolymer vapor 622 is ejected from the fluoropolymer target 618, 506 and coat the exposed surfaces 192 of the lithium carbonate layer 184 formed on the lithium layer 166. In the case of sputtering, the fluoropolymer target 618, 506 is impinged with ions 624, such as hydrogen ions that are generated either within the process chamber 606 or provided to the process chamber 606 from an ion generator 626 including a magnetron or ion gun, and fluoropolymer fragments are ejected from the target and impinge on the lithium carbonate layer 184.

Alternatively, the fluoropolymer layer 194 may be deposited by plasma assisted or thermally assisted chemical vapor deposition utilizing a chemical vapor deposition system 600 illustrated in FIG. 6. The processes include introducing a precursor gas such as one or more of hexafluoropropylene oxide (C₃F₆O), carbon tetrafluoride (CF₄), octafluorobutane (C₄F₈), trifluoromethane (CHF₃), difluoromethane (CH₂F₂), and fluoromethane (CH₃F) into the chemical vapor deposition chamber 606 by way of a gas supply 604 once a vacuum has been drawn on the process chamber 606. The gas precursors are then polymerized by plasma or thermal assistance. If plasma assisted, plasma ions, such as hydrogen ions, are ejected to interact with the precursor gas to provide a polymer film. If thermally assisted, a catalytic activator of nichrome mesh is used to catalyze the reaction.

At this stage, the lithium anode 158, on the anode current collector 154, or a generic substrate 502, may be packaged and shipped, or stored before assembly into a battery 126. Once formed, the hybrid coating layer 164 including the lithium carbonate layer 184 and the fluoropolymer layer 194 may protect the lithium anode 158, as illustrated in FIG. 4B. For example, the fluoropolymer layer 194 and lithium carbonate layer 184 may protect the lithium layer 166 from exposure to moisture allowing greater flexibility in the storage, shipment and integration of the lithium anode 158 into a battery 126. In addition, the fluoropolymer layer 194 may prevent the lithium carbonate layer from spalling. Further, the Li₂CO₃ prevents a defluorination reaction from occurring between the lithium and the fluoropolymer.

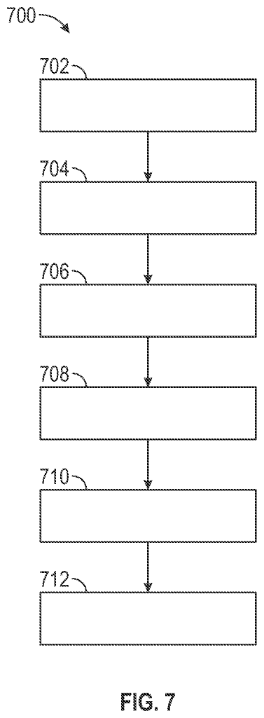

At block 308, the lithium anode 158 is assembled into a battery cell 150. During the assembly process 700, an embodiment of which is illustrated in FIG. 7, at block 702 the cathode electrode including the cathode current collector 152 and cathode 156, the separator 160, and the anode electrode including the anode 158 and anode current collector 154 are assembled into a battery cell 150 with a separator 160 placed between them. It should be appreciated that the cathode 156 and anode 158 are on opposing sides of the separator 160, the cathode 156 is positioned between the separator 160 and the cathode current collector 152, and the anode 158 is positioned between the separator 160 and the anode current collector 154. A separator 160 may be placed between two battery cells 150 as well. In embodiments, the separator 160 may be in the form of a ribbon and folded. The cathode electrode and anode electrode may be interleaved between folds of the separator 160. The separator may assume the general shape of a “z” around the cathode and anode electrodes, sometimes referred to as “z-folded.” In other embodiments, the cathode electrode, a first separator 160, the anode electrode, and a second separator 160, may be wrapped around a mandrel to form a battery cell 150.

Once the battery cell 150 is assembled, the battery cells 150 are baked at block 704 in a vacuum oven to minimize reactivity with environmental factors such as moisture and reactive gasses. During baking, a defluorination reaction occurs, as illustrated in FIG. 4C, transforming the lithium carbonate layer 184 and the fluoropolymer layer 194 into a composite of lithium fluoride (LiF) and lithium carbonate (Li₂CO₃) embedded in the hybrid coating layer 164. That is, the lithium fluoride and lithium carbonate form individual domains 196 within a carbonaceous matrix 198 in the hybrid coating layer 164. The carbonaceous matrix 198 includes one or more of carbon and short chain hydrocarbons having a chain length of no greater than that of the deposited polymer, resultant from the extraction of the fluorine atoms and exposure to elevated temperatures. As lithium carbonate prevents lithium ion (Li+) transport to the lithium anode 158, the formation of the domains 196 provides a pathway for lithium ion transport to the lithium anode 158. In embodiments, the baking temperature is less than the heat deflection temperature of the separator 160 material (if formed of a thermoplastic polymer), and greater than the vaporization temperature of water, including all values and ranges between the vaporization temperature of water and less than the heat deflection temperature of the separator 160.

At block 706, the tabs are welded to the cathode current collector 152 and the anode current collector 154. The baked battery cells 150 are arranged into an inner packaging or pouch 168 at block 708 and at block 710 the electrolyte 162 is introduced into the battery cells 150. The electrolyte 162 permeates through the separator 160 and contacts the cathode 156 and anode 158. Then the pouch 168 is sealed and placed into a casing 170 at block 712.

In embodiments, the contact between the lithium fluoride and lithium carbonate domains 196 in the carbonaceous matrix 198 creates a space charge, an increase in ionic diffusion in the solid-solid dispersion of the lithium fluoride and the lithium carbonate, which facilitates charge transfer. Further, the carbonaceous matrix 198 accommodates volume changes of the anode 158 during charge and discharge cycling, enhancing cycle stability. During the cycling process (charging and discharging) the defluorination reaction may continue.

The anodes, battery cells, batteries, and methods herein offer a number of advantages. These advantages include, for example, the formation of a flexible coating that allows for mechanical deformation and strain of the anode during shipping and cell assembly. These advantages further include protection of the lithium from moisture present in the environment during shipping and cell assembly as well as the potential for looser environmental controls in the battery manufacturing cell. These advantages yet further include the prevention of a defluorination reaction between the lithium and fluoropolymer during shipping and cell assembly due to the presence of the lithium carbonate layer, which acts as a buffer layer. An additional advantage includes the ability to trigger defluorination during battery formation. Yet an additional advantage includes the ability of the carbonaceous matrix to accommodate volume change of the anode and anode electrode during discharge and charge cycles.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semiconductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of forming a lithium ion battery, comprising:
exposing a first surface of a lithium layer to carbon dioxide gas;
forming a lithium carbonate layer on the first surface of the lithium layer; and
depositing a fluoropolymer layer on a second surface of the lithium carbonate layer to provide a lithium anode.

2. The method of claim 1, wherein forming the lithium carbonate layer includes forming the lithium carbonate layer exhibiting a thickness of less than 50 nanometers.

3. The method of claim 2, wherein depositing the fluoropolymer layer includes depositing a plurality of fluoropolymer fragments of a fluoropolymer using a physical deposition process, wherein the plurality of fluoropolymer fragments impinge on the lithium carbonate layer.

4. The method of claim 3, wherein depositing the fluoropolymer layer includes depositing a fluoropolymer layer having a thickness in the range of 5 nanometers to 100 nanometers.

5. The method of claim 4, wherein depositing the fluoropolymer layer includes depositing the plurality of fluoropolymer fragments of at least one of polyvinyl fluoride (PVD), polyvinylidene fluoride (PVDF), polytetrafluoroethylene (PTFE), polyhexafluoropropylene (PHFP), and polychlorotrifluoroethylene (PCTFE), tetrafluoroethylene (TFE), perfluoroalkoxy alkane (PFA), polytetrafluoroethylene perfluoro methylvinylether (methylfluoroalkoxy, MFA), ethylene tetrafluoroethylene (ETFE), fluorinated ethylene propylene (FEP), and ethylene-chlorotrifluoroethylene (ECTFE).

6. The method of claim 3, wherein depositing the fluoropolymer layer using a physical deposition process includes depositing the fluoropolymer layer by thermal evaporation of the fluoropolymer from a fluoropolymer target.

7. The method of claim 3, wherein depositing the fluoropolymer layer using a physical deposition process includes depositing the fluoropolymer layer by sputtering the fluoropolymer from a fluoropolymer target.

8. The method of claim 3, further comprising forming the lithium layer by thermally evaporating lithium and depositing the lithium on a substrate.

9. The method of claim 8, wherein the substrate is an anode current collector.

10. The method of claim 9, further comprising assembling the lithium anode into a battery cell.

11. The method of claim 10, wherein assembling the lithium anode into a battery cell includes positioning a separator between a cathode and the lithium anode.

12. The method of claim 11, wherein the cathode is formed on a cathode current collector and the anode is formed on an anode current collector.

13. The method of claim 11, further comprising defluorinating the fluoropolymer layer and forming a hybrid coating layer including a plurality of lithium fluoride domains and a plurality of lithium carbonate domains.

14. The method of claim 13, further comprising forming a carbonaceous matrix around the plurality of lithium fluoride domains and the plurality of lithium carbonate domains.

15. The method of claim 14, further comprising sealing the battery cell in a pouch and introducing an electrolyte into the battery cell.

16. An anode for a lithium ion battery, comprising:
a lithium layer including a first surface;
a lithium carbonate layer disposed on the first surface, wherein the lithium carbonate layer includes a second surface; and
a fluoropolymer layer disposed on the second surface.

17. The anode of claim 16, wherein the lithium carbonate layer exhibits a thickness of less than 50 nanometers.

18. The anode of claim 17, wherein the fluoropolymer layer exhibits a thickness of 5 nanometers to 100 nanometers.

19. The anode claim 18, wherein the fluoropolymer layer is formed of one or more of the following fluoropolymers: polyvinyl fluoride (PVD), polyvinylidene fluoride (PVDF), polytetrafluoroethylene (PTFE), polyhexafluoropropylene (PHFP), and polychlorotrifluoroethylene (PCTFE), tetrafluoroethylene (TFE), perfluoroalkoxy alkane (PFA), polytetrafluoroethylene perfluoro methylvinylether (methylfluoroalkoxy, MFA), ethylene tetrafluoroethylene (ETFE), fluorinated ethylene propylene (FEP), and ethylene-chlorotrifluoroethylene (ECTFE).

20. A lithium ion battery for a vehicle, comprising:
one or more battery cells, wherein each battery cell includes a cathode disposed on a cathode current collector, an anode disposed on an anode current collector, a porous separator between the cathode and anode, and an electrolyte infiltrating the porous separator, wherein the anode includes:
a lithium layer including a first surface, and
a hybrid coating layer disposed on the first surface, wherein the hybrid coating layer includes a plurality of lithium fluoride domains and a plurality of lithium carbonate domains within a carbonaceous matrix;
a pouch defining a volume for receiving the battery cell;
an anode tab welded to a portion of the anode current collector extending from the pouch; and
a cathode tab welded to a portion of the cathode current collector extending from the pouch.
